(19) United States
(12) Patent Application Publication
(10) Pub. No.: US 2011/0293993 A1
(43) Pub. Date: Dec. 1, 2011

(54) ELECTRICITY STORAGE SYSTEM

(75) Inventor: Heeyeon Ryu, Gwangju (KR)

(73) Assignees: KIA MOTORS CORPORATION, Seoul (KR); HYUNDAI MOTOR COMPANY, Seoul (KR)

(21) Appl. No.: 12/900,743

(22) Filed: Oct. 8, 2010

(30) Foreign Application Priority Data
May 28, 2010 (KR) 10-2010-0050472

(51) Int. Cl. H01M 16/00

(52) U.S. Cl. 429/156

(57) ABSTRACT

The present invention relates to an electricity storage system, which has high energy density, which is a property of a lithium-sulfur battery cell, and can perform high-speed output and high-speed charging/discharging which are properties of an electrochemical capacitor cell, while having high output and high energy density, by stacking the electrochemical capacitor cell on the lithium-sulfur battery cell.

### CROSS-REFERENCE TO RELATED APPLICATIONS

The present application claims under 35 U.S.C. §119(a) priority to Korean Patent Application No. 10-2010-0050472 filed May 28, 2010, the entire contents of which application is incorporated herein for all purposes by this reference.

### BACKGROUND OF THE INVENTION

1. Field of the Invention

The present invention relates generally to an electricity storage system, and more particularly, to an electricity storage system having high power and high energy density.

2. Description of Related Art

Most vehicles use an engine, which operates by using gasoline or diesel, as a power source. However, as environmental pollution has becomes a worldwide concern, electric vehicles using an electric motor are receiving an increasing amount of attention.

Electricity storage systems for the electric vehicles can repeat charging and discharging, because interconversion is reversible between chemical energy and electric energy. The electricity storage systems preferably include an electrode assembly having a cathode plate and an anode plate with a separator therebetween, a case having a space for housing the electrode assembly, and a cap plate combined with the case to seal it.

A lithium ion battery is mostly used for hybrid vehicles at the present in the electricity storage systems and has theoretic energy density of 570 Wh/kg. However, energy density that can be practically achieved in the lithium ion battery is 250 Wh/kg, such that it has a limit to apply to the electric vehicles that are required to travel over 500 km with one-time charging.

Therefore, a lithium-sulfur battery theoretically having high energy density of 2600 Wh/kg has been noted to implement high energy density for the electric vehicles. Further, many studies have been conducted to increase the realizable energy density of the lithium-sulfur battery.

However, the operational voltage of a lithium-sulfur battery is 2.0 to 2.5V, which is smaller than that (3.7V) of the existing lithium ion batteries, and the power density is also low.

The information disclosed in this Background of the Invention section is only for enhancement of understanding of the general background of the invention and therefore it may contain information that does not form the prior art that is already known in this country to a person of ordinary skill in the art.

### BRIEF SUMMARY OF THE INVENTION

Preferred aspects of the present invention provide an electricity storage system that has high energy density and high output and can preferably perform high-speed charging or discharging, by stacking an electrochemical capacitor cell on a lithium-sulfur battery cell.

Preferred embodiments of the present invention provide an electricity storage system, which includes a lithium-sulfur battery cell that preferably includes a battery anode plate, a battery cathode plate, and a separator suitably disposed between the battery anode plate and the battery cathode plate for electric insulation therebetween; and an electrochemical capacitor cell that is suitably stacked to be electrically insulated from the lithium-sulfur battery cell by a cell separator and preferably includes a capacitor anode plate, a capacitor cathode plate, and a capacitor separator suitably disposed between the capacitor anode plate and the capacitor cathode plate for electric insulation therebetween.

Preferably, the cell separator may be a porous separator allowing movement of electrons and ions of the lithium-sulfur battery cell and the electrochemical capacitor cell, and electrically separating the lithium-sulfur battery cell from the electrochemical capacitor cell.

Electrolytes that are disposed between the battery anode plate and the battery separator and between the battery cathode plate and the battery separator in the lithium-sulfur battery cell may be the same as electrolytes suitably disposed between the capacitor anode plate and the capacitor separator and between the capacitor cathode plate and the capacitor separator in the electrochemical capacitor cell.

Preferably, a plurality of the lithium-sulfur battery cells and a plurality of the electrochemical capacitor cells may be alternately stacked.

An electricity storage system according to certain preferred embodiments of the present invention has high energy density and high output and can suitably perform high-speed charging/discharging, by stacking an electrochemical capacitor cell on a lithium-sulfur battery cell.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated by the accompanying drawings which are given hereinafter by way of illustration only, and thus are not limitative of the present invention, and wherein:

FIG. 1 is a view illustrating the structure of an electricity storage system according to an embodiment of the present invention.

FIG. 2 is a view illustrating the structure of the lithium-sulfur battery cell of FIG. 1.

FIG. 3 is a view illustrating the structure of the electrochemical capacitor cell of FIG. 1.

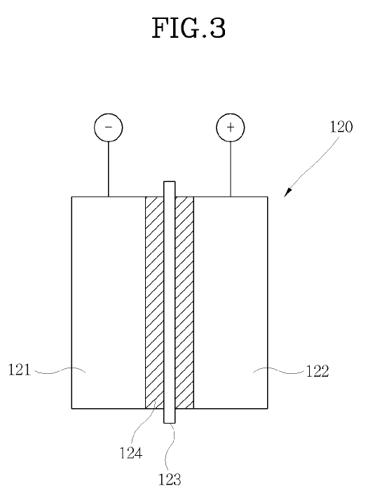

FIG. 4 is a view illustrating the structure of an electricity storage system according to another embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION OF THE INVENTION

As described herein, in preferred embodiments, the present invention features an electricity storage system, comprising a lithium-sulfur battery cell comprising a battery anode plate, a battery cathode plate, and a separator, and an electrochemical capacitor cell comprising a capacitor anode plate, a capacitor cathode plate, and a capacitor separator.

In one embodiment, the separator is disposed between the battery anode plate and the battery cathode plate for electric insulation therebetween.

In another embodiment, the electrochemical capacitor cell is stacked to be electrically insulated from the lithium-sulfur battery cell by a cell separator.

In another further embodiment, the capacitor separator is disposed between the capacitor anode plate and the capacitor cathode plate for electric insulation therebetween.

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

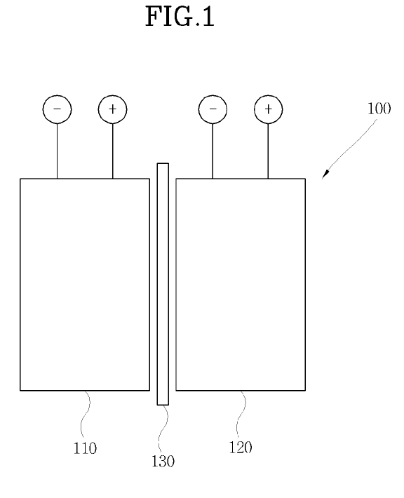

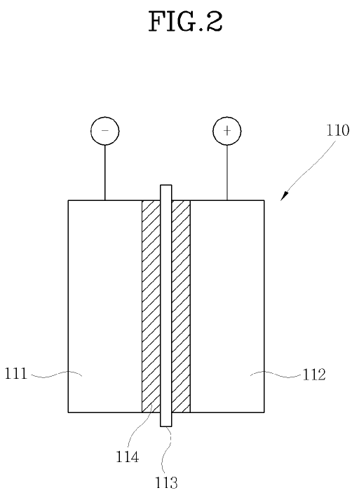

In a preferred embodiment, and referring to FIGS. 1 and 2 for example, an electricity storage system 100 preferably includes a lithium-sulfur battery cell 110 and an electrochemical capacitor cell 120.

According to further preferred embodiments, a lithium-sulfur battery cell 110 is composed of a battery anode plate 111, a battery cathode plate 112, and a separator 113 that is suitably disposed between a battery anode plate 111 and a battery cathode plate 112.

Preferably, a battery anode plate 111 is suitably composed of an anode collector and at least one active material in lithium, a lithium alloy, and a composite containing lithium.

Preferably, a battery cathode plate 112 is suitably composed of a cathode collector and at least one active material in sulfur, a sulfur alloy, and a composite containing sulfur.

According to preferred embodiments of the present invention, a battery separator 113 is a porous separator electrically insulating a battery anode plate 111 from a battery cathode plate 112 by preventing contact between the battery anode plate 111 and the battery cathode plate 112 and allowing lithium ions to move in charging/discharging.

Preferably, a lithium-sulfur battery cell 110 includes electrolytes 114 that are suitably disposed between a battery anode plate 111 and a battery separator 113 and between a battery cathode plate 112 and a battery separator 113, respectively. Preferably, a lithium-sulfur battery cell 110 having this configuration has a high energy density of theoretically 2600 Wh/kg.

According to further preferred embodiments of the present invention, an electrochemical capacitor cell 120 is composed of a capacitor anode plate 121, a capacitor cathode plate 122, and a capacitor separator 123 suitably disposed between a capacitor anode plate 121 and a capacitor cathode plate 122.

According to preferred embodiments of the present invention, a capacitor anode plate 121 and a capacitor cathode plate 122 each include a polarity collector, an active material for each polarity which is suitably disposed between the polarity collector and capacitor separator 123, a conductor providing conductivity, and a binder increasing bonding force between the active material and the conductor. Preferably, the active material of the capacitor anode plate 121 may be a CNT (Carbon Nano-Tube) and the active material of capacitor cathode plate 122 may be MnO₂.

In this configuration, according to certain preferred embodiments of the present invention, a capacitor separator 123 is a porous separator electrically insulating capacitor anode plate 121 from capacitor cathode plate 122 by suitably preventing contact between capacitor anode plate 121 and capacitor cathode plate 122 and allowing electrons and electrolyte ions to move in charging/discharging.

According to certain preferred embodiments, an electrochemical capacitor cell 120 preferably includes electrolytes 124 that are suitably disposed between capacitor anode plate 121 and capacitor separator 123 and between capacitor cathode plate 122 and capacitor separator 123, respectively. Preferably, an electrolyte 124 of electrochemical capacitor cell 120 is the same as the electrolyte 114 of lithium-sulfur cell 110. According to certain preferred embodiments, the electrolyte includes LiCF3So3, LiTFSi, and DME (dimethoxy ethane).

In further preferred embodiments of the present invention, in an electrochemical capacitor cell 120, electrons faster than ions moves between capacitor anode plate 121 and capacitor cathode plate 122 for charging or discharging, such that high energy can be suitably stored or discharged for a short time.

Preferably, an electrochemical capacitor cell 120 is suitably stacked on a lithium-sulfur cell 110 to be electrically insulated from a lithium-sulfur battery cell 110 by a cell separator 130.

According to further preferred embodiments of the present invention, a cell separator 130 can electrically insulate a lithium-sulfur battery cell 110 from an electrochemical capacitor cell 120 by being suitably disposed between a battery cathode plate 112 of a lithium-sulfur battery cell 110 and capacitor anode plate 121 of electrochemical capacitor cell 120. In other certain embodiments, a cell separator 130 can electrically insulate lithium-sulfur battery cell 110 from electrochemical capacitor cell 120 by being suitably disposed between battery anode plate 111 of lithium-sulfur battery cell 110 and capacitor cathode plate 122 of electrochemical capacitor cell 120.

Accordingly, in other further exemplary embodiments, a cell separator 130 is suitably disposed between a lithium-sulfur battery cell 110 and an electrochemical capacitor cell 120 to electrically insulate the cells by suitably preventing contact between the polar plates of the lithium-sulfur battery cell 110 and the electrochemical capacitor cell 120.

Preferably, a cell separator 130 is formed of a porous separator for easy movement of the ions and electrons of lithium-sulfur battery cell 110 and the ions and electrons of electrochemical capacitor cell 120. Accordingly, since a lithium-sulfur battery cell 110 and an electrochemical capacitor cell 120 are electrically insulated by a cell separator 130 and the electrons and ions can move, such that they can supplement each other in charging/discharging.

According to other further embodiments of the present invention, an electricity storage system 100 further includes a case (not shown) which has a space housing lithium-sulfur battery cell 110 and electrochemical capacitor cell 120 and the case may be fully filled with electrolytes 114, 124.

According to other further embodiments, the electricity storage system 100 has high energy density, which is a property of lithium-sulfur battery cell 110, and can perform high-speed output and high-speed charging/discharging which are properties of electrochemical capacitor cell 120, by stacking electrochemical capacitor cell 120 on lithium-sulfur battery cell 110. Accordingly, an electricity storage system 100 can have suitably high output and high energy density by complement low output, which is a defect of a lithium-sulfur battery cell 110, and low energy density of electrochemical capacitor cell 120, by suitably stacking electrochemical capacitor cell 120 and lithium-sulfur battery cell 110.

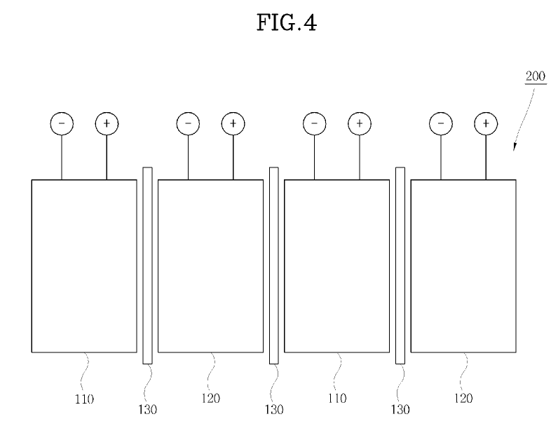

Further, an electricity storage system 200, for example as shown in FIG. 4, may be preferably composed of a plurality of cells formed by alternately stacking lithium-sulfur battery cells 110 and of electrochemical capacitor cells 120. Alternatively, in other certain embodiments, an electricity storage system 200 may be preferably composed of a plurality of cells formed by irregularly stacking lithium-sulfur battery cells 110 and of electrochemical capacitor cells 120.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An electricity storage system, comprising:
a lithium-sulfur battery cell that includes a battery anode plate, a battery cathode plate, and a separator disposed between the battery anode plate and the battery cathode plate for electric insulation therebetween; and
an electrochemical capacitor cell that is stacked to be electrically insulated from the lithium-sulfur battery cell by a cell separator and includes a capacitor anode plate, a capacitor cathode plate, and a capacitor separator disposed between the capacitor anode plate and the capacitor cathode plate for electric insulation therebetween.

2. The electricity storage system as defined in claim 1, wherein the cell separator is a porous separator allowing movement of electrons and ions of the lithium-sulfur battery cell and the electrochemical capacitor cell, and electrically separating the lithium-sulfur battery cell from the electrochemical capacitor cell.

3. The electricity storage system as defined in claim 1, wherein electrolytes are disposed between the battery anode plate and the battery separator and between the battery cathode plate and the battery separator in the lithium-sulfur battery cell, and the same electrolytes are disposed between the capacitor anode plate and the capacitor separator and between the capacitor cathode plate and the capacitor separator in the electrochemical capacitor cell.

4. The electricity storage system as defined in claim 1, wherein a plurality of the lithium-sulfur battery cells and a plurality of the electrochemical capacitor cells are alternately stacked.

5. An electricity storage system, comprising:
a lithium-sulfur battery cell comprising a battery anode plate, a battery cathode plate, and a separator; and
an electrochemical capacitor cell comprising a capacitor anode plate, a capacitor cathode plate, and a capacitor separator.

6. The electricity storage system of claim 5, wherein the separator is disposed between the battery anode plate and the battery cathode plate for electric insulation.

7. The electricity storage system of claim 5, wherein the electrochemical capacitor cell is stacked to be electrically insulated from the lithium-sulfur battery cell by a cell separator.

8. The electricity storage system of claim 5, wherein the capacitor separator is disposed between the capacitor anode plate and the capacitor cathode plate for electric insulation.
